(19) United States
(12) Patent Application Publication
(10) Pub. No.: US 2011/0198306 A1
(43) Pub. Date: Aug. 18, 2011

(54) Locker shelf assembly kit with extension shelves, locker shelf assembly and method of assembling the shelf assembly in a locker

(76) Inventors: Thomas Moritz, Kendall Park, NJ (US); Ian Moritz, Kendall Park, NJ (US)

(21) Appl. No.: 13/066,513

(22) Filed: Apr. 15, 2011

Related U.S. Application Data
(63) Continuation-in-part of application No. 12/386,066, filed on Apr. 14, 2009.

(51) Int. Cl. A47F 5/08; A47B 96/02; B23P 11/00

(52) U.S. Cl. 211/90.01; 211/153; 29/428

(57) ABSTRACT

The method for constructing a shelf assembly in a locker having on each side thereof a generally vertically extending longitudinal lip, the lip on one side of the locker hingedly mounting a locker door, comprises the steps of: providing a first sidewall having in an inner sidewall surface thereof a transverse slot located generally midway between upper and lower ends of the sidewall and an inner shoulder at the upper end of the sidewall and a second sidewall having in an inner sidewall surface thereof a transverse slot located generally midway between the upper and lower ends of the sidewall and an inner shoulder at the upper end of the sidewall a first shelf and a second shelf: Inserting the first sidewalls in the locker against a sidewall of the locker; Inserting the second sidewall in the locker higher than the first sidewall and holding the second sidewall at that higher position while the first shelf is inserted at an angle but with side edges of the shelf generally aligned with the slots; lowering the second sidewall and the first shelf with the side edges of the shelf engaging in the slots; and, once the lower ends of the sidewalls are firmly supported on a bottom of the locker, inserting the second shelf on the shoulders of the sidewalls and a shelf extension with a shelf extension member and a connector framework. A kit for constructing the locker shelf assembly also is provided.

### CROSS REFERENCE TO RELATED APPLICATIONS

This application is a continuation in part of U.S. application Ser. No. 12/386,066, filed Apr. 14, 2009.

### BACKGROUND OF THE INVENTION

1. Field of the Invention

The present invention relates to a simple shelf assembly which is assembled inside a student's locker at a high school, college or military base, etc.. More specifically, the present invention relates to a four piece shelf assembly including two side wall portions and two shelf portions and shelf extensions to create a 12 inch or 15 inch wide shelf.

2. Description of the Prior Art

Heretofore, various shelf assemblies have been proposed for placement in a student's locker. Examples of these prior art shelf assemblies are disclosed in the following U.S. patents and application:

| U.S. Pat. No.: | Patentee |
|---|---|
| 4,500,146 | Richard R. Peterson |
| 4,808,875 | John C. Edwards |
| 4,818,044 | Bradley M. Dobry |
| 5,137,160 | Donald C. Santucci |
| 5,221,013 | Donald C. Santucci |
| 5,251,973 | Syd Hazan |
| 5,421,646 | McNamara et al. |
| 5,474,192 | Dane E. Hartzell |
| 5,671,990 | Mark Teasdale |
| 6,814,418 | Ronald D'orso |
| 6,877,826 | Wood et al. |
| D522,284 | Shapiro et al. |
| US2006/0186769 | Jerry Harris |

### BRIEF SUMMARY OF THE INVENTION

According to the teachings of the present invention, there is provided a method for constructing a shelf assembly in a locker having on each side thereof a generally vertically extending longitudinal lip, the lip on one side of the locker hingedly mounting a locker door, the method comprising the steps of:
providing a first sidewall having in an inner sidewall surface thereof a transverse slot located generally midway between upper and lower ends of the sidewall and an inner shoulder at the upper end of the sidewall and a second sidewall having in an inner sidewall surface thereof a transverse slot located generally midway between the upper and lower ends of the sidewall and an inner shoulder at the upper end of the sidewall a first shelf and a second shelf:
Inserting the first sidewalls in the locker against a sidewall of the locker;
Inserting the second sidewall in the locker higher than the first sidewall and holding the second sidewall at that higher position while the first shelf is inserted at an angle but with side edges of the shelf generally aligned with the slots
lowering the second sidewall and the first shelf with the side edges of the shelf engaging in the slots; and
once the lower ends of the sidewalls are firmly supported on a bottom of the locker, inserting the second shelf on the shoulders of the sidewalls.

Further according to the teachings of the present invention there is provided a locker shelf assembly kit comprising first and second sidewalls, each having In an inner-wall surface thereof a transverse slot extending across the sidewall midway between the top and bottom thereof and an inner shoulder at the upper edge of each sidewall and first and second shelves dimensioned to be received either on the transverse grooves or on top of the inner shoulders at the top of each sidewall for forming shelves and being supported by each sidewall.

Additionally according to the teachings of the present invention there is provided a locker shelf assembly constructed inside a locker behind generally vertically extending longitudinal front lips thereof on each side of the locker, the locker shelf assembly comprising first and second sidewalls, each having in an inner wall surface thereof a transverse slot extending across the sidewall and an inner shoulder at the upper end of each sidewall and a first shelf adapted to be received within the slots of the sidewalls and a second shelf adapted to be received on and supported by the inner shoulders at the top of the sidewalls and with the sidewalls of the locker providing side support for the locker shelf assembly and the bottom wall of the locker providing vertical support for the locker shelf assembly.

Also provided are specially constructed shelf extension members for creating 12 inch or 15 inch wide shelves. Each shelf extension member is mounted with a connector framework to an upper or lower shelf.

### BRIEF DESCRIPTION OF SEVERAL VIEWS OF THE DRAWINGS

FIG. 1 is an elevational view of three lockers with an un-assembled shelf assembly of the present invention comprising 4 pieces situated adjacent one of the lockers.

FIG. 2 is a front elevational view of an open locker with generally vertically extending longitudinal lips at the side edges of the open locker omitted and the front door of the locker omitted and shows two side walls of the shelf assembly positioned in the locker adjacent side walls of the locker while being supported by a bottom of the locker with a lower shelf being inserted into position between the two side walls.

FIG. 3 is a front view of the open locker similar to FIG. 2 with the vertically extending longitudinal lips of the locker omitted and with the door omitted to show the completed assembly of the shelf assembly in the locker.

FIG. 4 is a top view of the open locker having the completed shelf assembly therein and showing the vertically extending longitudinal lips of the locker and the locker door partially open.

FIG. 5 is a plan view of a 3 inch shelf extension added to a lower or upper shelf to create a 12 inch shelf.

FIG. 6 is a plan view of two 3 inch shelf extensions added to a lower or upper shelf to create a 12 inch shelf.

FIG. 7 is a perspective view of a connector framework which is used to mount the shelf extensions to a shelf.

FIG. 8 is a perspective view of a shelf extension member.

FIG. 9 is a perspective view of a connector framework position at an angle over a shelf extension member.

FIG. 10 is a plan view of a shelf extension member and connector framework adjacent a shelf for insertion into the shelf

### DETAILED DESCRIPTION OF THE INVENTION

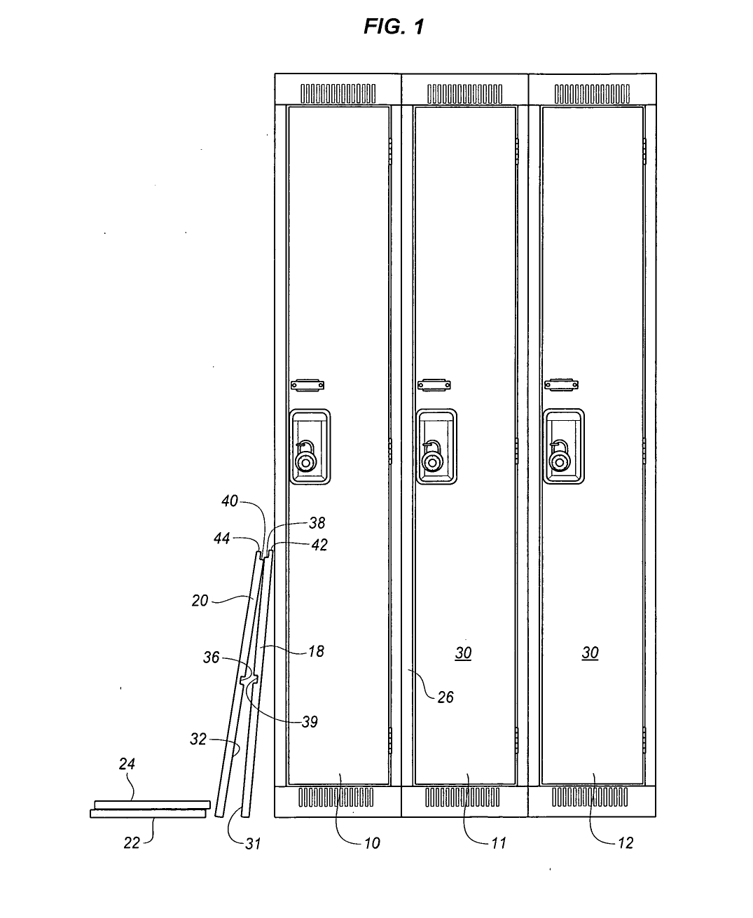

Referring now to FIG. 1 there is illustrated therein a set of three lockers 10, 11 and 12 in a locker room in a school hallway, and adjacent the left locker is the un-assembled shelf locker assembly 16 or locker shelf assembly kit of the present invention, which comprises a first side wall 18, a second side wall 20, a first lower shelf 22 and a second upper shelf 24.

It is to be noted that each of the lockers has a generally vertically extending longitudinal lip 26, 28 on each side of the locker and a locker door 30 is hingedly mounted to the lip 28.

As will be described below the locker shelf assembly is assembled in a locker from a locker shelf assembly kit comprising the first and second sidewalls 18 and 20, each having in an inner-wall surface 31, 32 thereof a transverse slot 34, 36 extending across the sidewall generally midway between the top and bottom thereof and an inner shoulder 38, 40 at an upper end 42, 44 of each sidewall 18, 20 and the first and second shelves 22, 24 dimensioned to be received either in the transverse slots 34, 36 or on top of the inner shoulders 38, 40 at the top of each sidewall 18, 20 for forming shelves and being supported by each sidewall 18, 20.

In one preferred embodiment the slot 34, 38 in each sidewall 18, 20 has a thickness of approximately 0.75 inch, each slot has a width of approximately 0.75 inch and each shelf has a thickness of approximately 0.75 inch.

Further in this embodiment, the sidewalls 19, 20 have a length of approximately 25, 4 inches and a depth of approximately 10 inches into the locker and each shelf 22,24 has a width of approximately 8 inches and a depth of approximately 10 inches.

Additionally at least side edges of the of the first shelf 22 are bevelled or rounded to facilitate entry of said side edges into said slots, For simplifying manufacture of the parts of the shelf assembly, both shelves 22, 24 can have bevelled or rounded side edges although flat side edges also will fit into the slots 34, 36.

Still further in this embodiment the distance from the bottom of each sidewall 18, 20 to the slot 34, 36 is 13 inches and the distance from the slot 32, 36 to the shoulder 38, 40 is 11.5 inches.

The dimensions of the walls and shelves will vary depending on the dimensions of the locker.

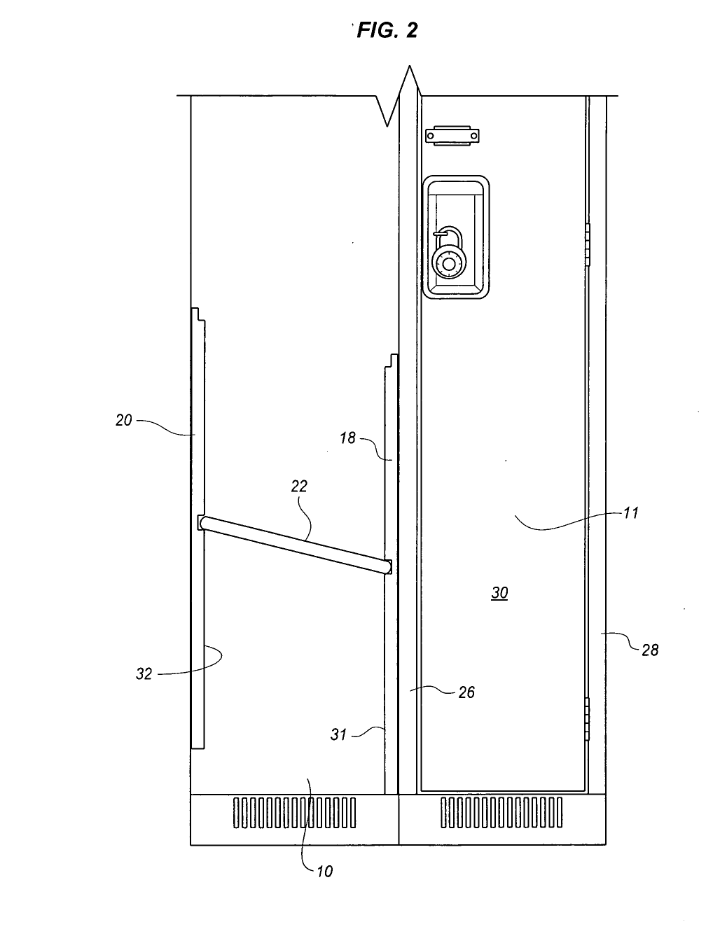

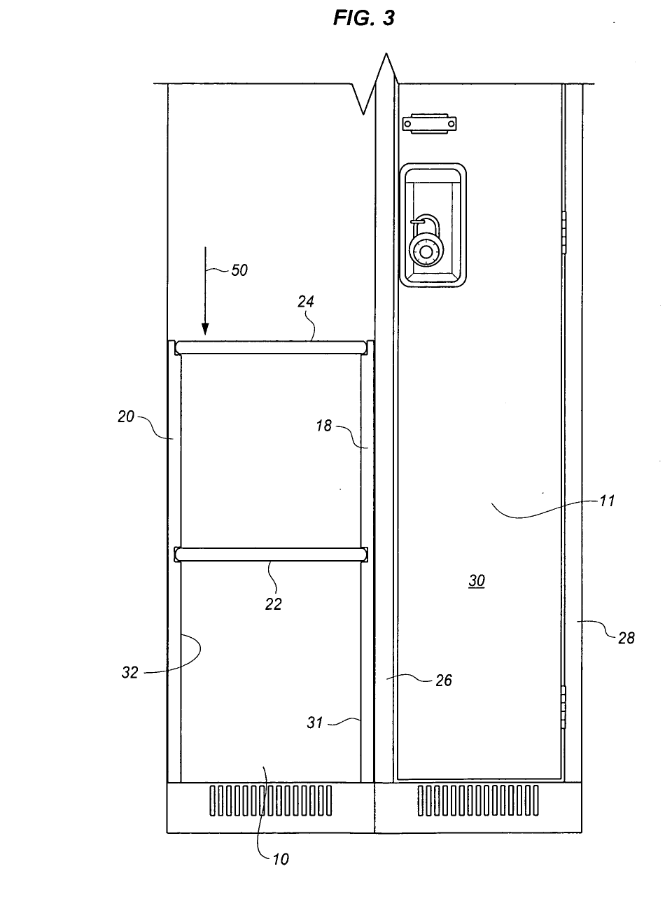

Referring now to FIG. 2 there is illustrated therein an open locker 10 with the generally vertically extending longitudinal lips 26, 28 omitted for clarity and the locker door 30 omitted for clarity.

It will be appreciated that the first side wall 18 is first inserted into the open locker 10. Then the second sidewall 20 is inserted at a higher position to the first sidewall 18 and the first lower shelf 22 is inserted at an angle with the side edges of the first shelf aligned with the slots 34, 36. then the second shelf is lowered with side edges of the first shelf 22 engaging in the slots 34, 36 until both sidewalls 18, 20 are firmly supported on the bottom of the locker. Then the second shelf 36 is positioned on the inner shoulders 38, 40. In this way, a shelf assembly 50 is constructed within the locker 10 notwithstanding the lips 26, 28 which would normally prevent a shelf assembly to be inserted into the locker.

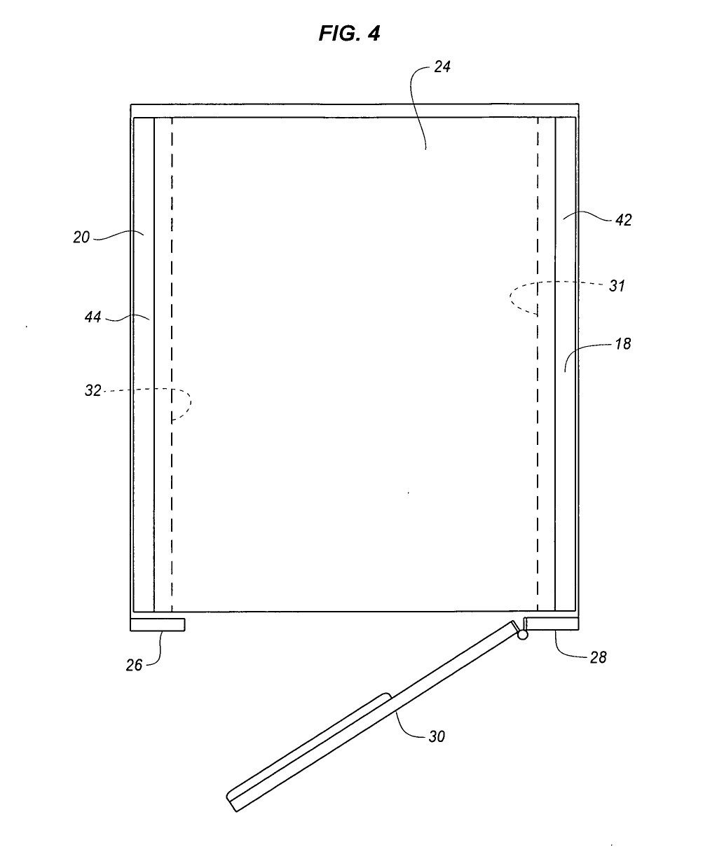

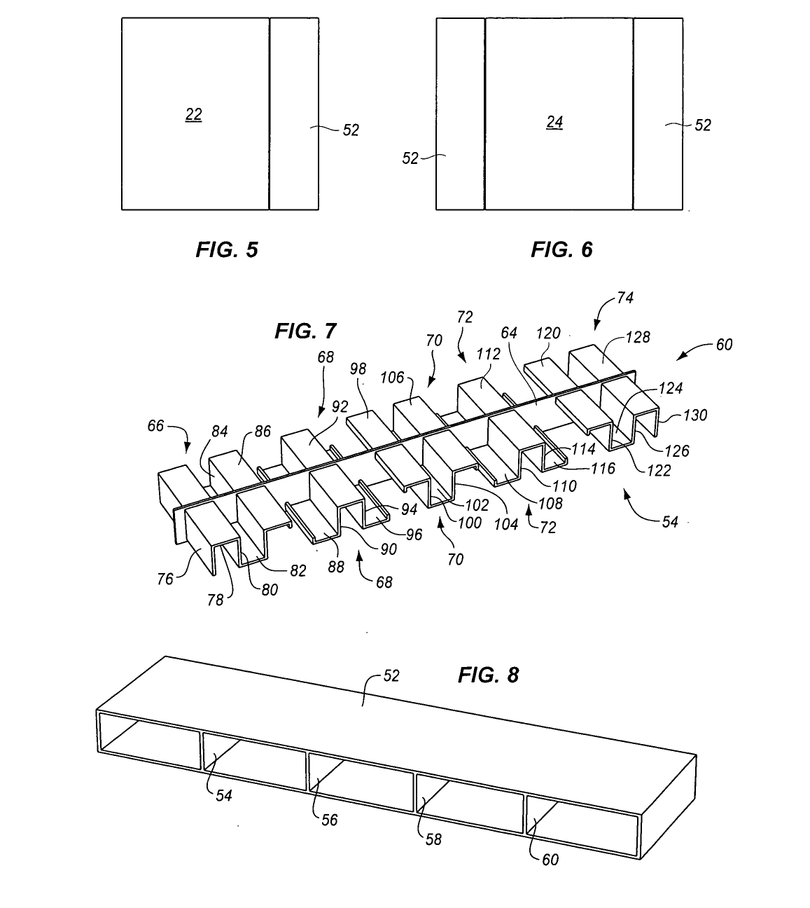

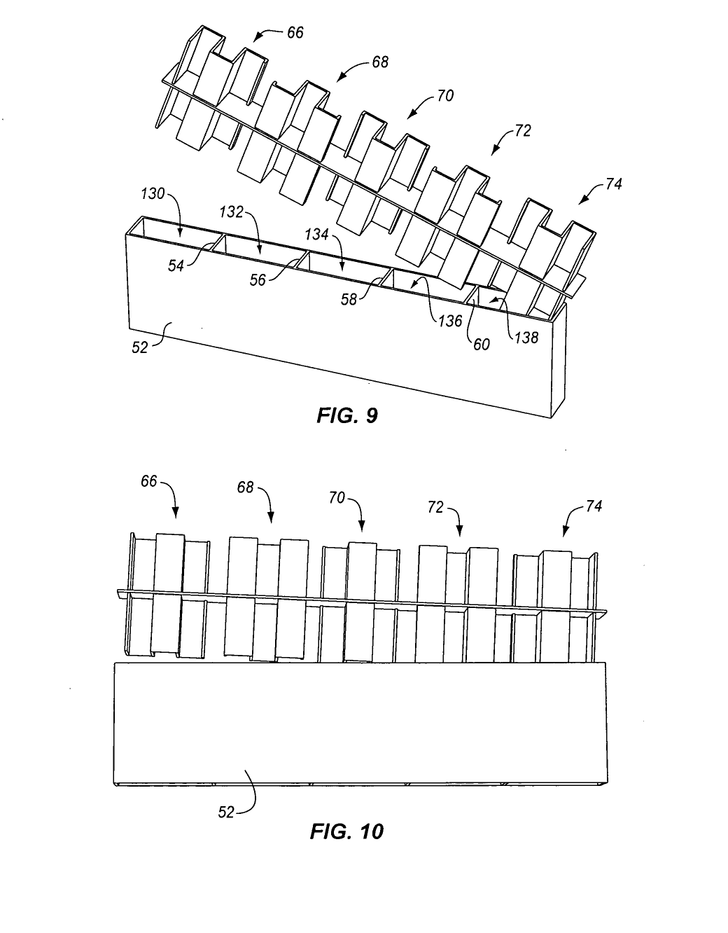

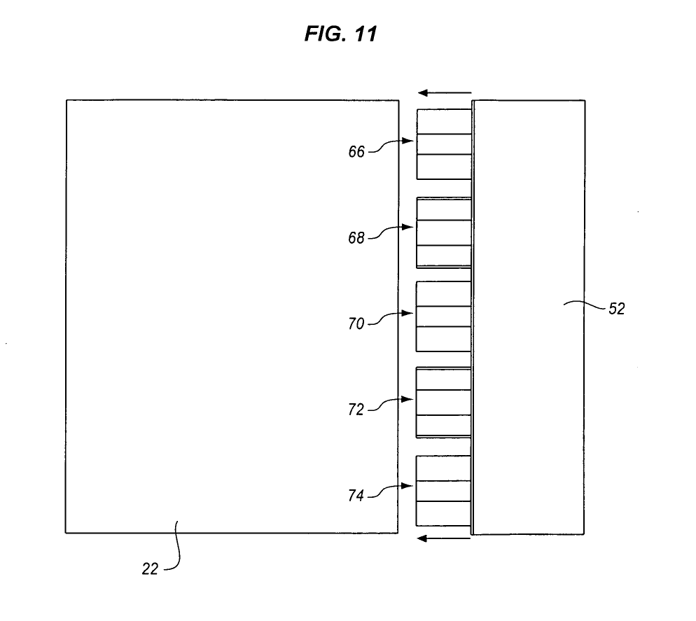

As shown in FIG. 4, the shelf assembly 50 provides upper and lower shelves 22, 24 extending between the two sidewalls 18, 30 of the shelf assembly 50 which press against the sidewalls within the locker. These shelves enable a student to place books on the shelves between classes and enables a student to have more beneficial use of the locker for temporarily storing books and papers.

The locker shelf assembly 50 of the present invention has a number of advantages some of which have been described above and others of which are inherent in the invention. In particular, it enables one to assemble a shelf assembly within a locker rather than inserting a constructed shelf assembly into a locker. This is beneficial because if a shelf assembly was inserted into a locker it would need to be narrower than the edges of the generally vertically extending longitudinal lips 26, 28 of the locker.

Further, the shelf assembly 50 and shelf extension members 52 to be described below of the present invention and the method of constructing same enables construction of the shelf assembly 50 and shelf extension members 52 in the locker with the bottom wall and the sidewalls of the locker supporting the shelf assembly 50 in the locker.

Where the width of the locker is larger than 9 inches, such as for example 12 inches or 15 inches the upper and lower shelves 22, 24 can be extended with shelf extension members 52 as shown in FIG's 5-11.

Each shelf extension member 52 is generally hollow with 4 partition walls 54, 56, 58, and 60 therein.

A connector framework 62 comprising a central elongate plate or center bar 64 has five bridge frames 66, 68, 70, 72 and 74 attached thereto each having a half extending from side of the center bar 64. This framework 62 is inserted into one half of a shelf extension member 52 and into an upper or lower shelve 22 or 24.

As shown in FIG. 7, the connector framework 62 comprises specially con figured bridge frames, 66, 68, 70 72 and 74 mounted on said dividing plate or center bar 64.

Bridge frame 66 comprises an upwardly extending plate 76 connected to a generally top planar plate 78 which is connected to a downwardly extending side plate 80. A bottom plate 82 extends from the side plate 80 to an upwardly extending side plate 84 that extends to a top plate 86.

Bridge frame 68 comprises a first bottom plate 88 that extends to a first upwardly extending side plate 90 that extends to a top plate 92. A second downwardly extending side plate 94 extends downwardly to a second bottom plate 96.

The bridge frame 70 comprises a first top plate 98 connected to a first downwardly extending side plate 100 which extends to a bottom plate 102 that connects to a second upwardly extending side plate 104 that connects to a second top plate 106.

The bridge frame 72 comprises a structure identical with the structure of the bridge frame 68 with a first bottom plate 108, a first upwardly extending side plate 110, a top plate 112, a second downwardly extending side plate 114 and a second bottom plate 116.

Finally, the last bridge frame 74 has an inverse construction to the bridge frame 66 and comprises a top plate 120 connected to a first downwardly extending side plate 122 which is connected to a bottom plate 124 which extends to a second upwardly extending side plate 126 that is connected to a top plate 128 that extends to a third downwardly extending side plate 1130.

The 5 bridge frames extend into five compartments 130, 132, 134, 136 and 138 created in the shelf extension member 52 by the 4 partition walls 54, 56, 58, and 60 therein.

The reinforcing structure of the bridge frames 66, 68, 70 72 and 74 insure that there is sufficient support in the shelf extension members 52.

It will be understood that modifications can be made to the shelf assembly 50 and sheet extension members 52 of the present invention, without departing from the teachings of the invention. Accordingly, the scope of the invention is only to be limited as necessitated by the accompanying claims.

I claim:

1. A locker shelf assembly kit comprising first and second sidewalls, each having in an inner-wall surface thereof a transverse slot extending across the sidewall generally midway between the top and bottom thereof and an inner shoulder at the upper end of each sidewall and first and second shelves dimensioned to be received either in the transverse slots or on top of the inner shoulders at the top of each sidewall for forming shelves and for being supported by each sidewall, each shelve being capable of mounting one or two shelf extension members each with a connector framework.

2. The locker shelf assembly kit of claim 1 where said slot in each sidewall has a thickness of approximately 0.75 inch, each slot has a width of approximately 0.75 inch and each shelf has a thickness of approximately 0.75 inch.

3. The locker shelf assembly kit of claim 1 where the sidewalls have a length of approximately 25.4 inches and a depth of approximately 10 inches and each shelf has a width of approximately 8 inches and a depth of approximately 10 inches.

4. The locker shelf assembly kit of claim 1 wherein at least side edges of said first shelf are bevelled or rounded to facilitate entry of said side edges into said slots.

5. The locker shelf assembly kit of claim 1 wherein each shelf extension member has a width of approximately 3 inches and is hollow with 5 openings extending through the shelf extension member and the connector framework comprises an elongate center bar an 5 bridge frames which are mounted to and extend form either side of the center bar and the bridge frames are received in each shelf extension member and in one of the upper or lower shelves.

6. A locker shelf assembly constructed inside a locker behind generally vertically extending longitudinal front lips thereof on each side of the locker, said locker shelf assembly comprising first and second sidewalls, each having in an inner wall surface thereof a transverse slot extending across the sidewall and an inner shoulder at the upper end of each sidewall and a first shelf adapted to be received within said slots of said sidewalls and a second shelf adapted to be received on and supported by said inner shoulders at the top of said sidewalls and with the sidewalls of the locker providing side support for the locker shelf assembly and the bottom wall of the locker providing vertical support for the locker shelf assembly, each shelve being capable of mounting one or two shelf extension members each with a connector framework.

7. The locker shelf assembly of claim 6 where the slot in each sidewall has a width of approximately 0.75 inch, each slot has a width of approximately 0.75 inch and each shelf has a thickness of approximately 0.75 inch.

8. The locker shelf assembly of claim 6 where said sidewalls have a length of approximately 25, 4 inches and a depth of approximately 10 inches and each shelf has a width of approximately 8 inches and a depth of approximately 10 inches.

9. The locker shelf assembly of claim 6 wherein at least side edges of said first shelf are bevelled or rounded to facilitate entry of said side edges into said slots.

10. A method for constructing a shelf assembly in a locker having on each side thereof a generally vertically extending longitudinal lip, the lip on one side of the locker hingedly mounting a locker door, said method comprising the steps of:
providing a first sidewall having in an inner sidewall surface thereof a transverse slot located generally midway between upper and lower ends of the sidewall and an inner shoulder at the upper end of said sidewall and a second sidewall having in an inner sidewall surface thereof a transverse slot located generally midway between the upper and lower ends of the sidewall and an inner shoulder at the upper end of said sidewall a first shelf and a second shelf:
Inserting the first sidewalls in the locker against a sidewall of the locker;
Inserting the second sidewall in the locker higher than the first sidewall and holding the second sidewall at that higher position while the first shelf is inserted at an angle but with side edges of the shelf generally aligned with said slots,
lowering the second sidewall and the first shelf with the side edges of the shelf engaging in said slots; and
once the lower ends of the sidewalls are firmly supported on a bottom of said locker, inserting the second shelf on the shoulders of the sidewalls, and creating a shelf extension with a shelf extension member and a connector framework.

11. The locker shelf assembly of claim 10 where the slot in each sidewall has a width of approximately 0.75 inch, each slot has a width of approximately 0.75 inch and each shelf has a thickness of approximately 0.75 inch.

12. The locker shelf assembly of claim 10 where said sidewalls have a length of approximately 25, 4 inches and a depth of approximately 10 inches and each shelf has a width of approximately 8 inches and a depth of approximately 10 inches.

13. The locker shelf assembly of claim 10 wherein at least side edges of said first shelf are bevelled or rounded to facilitate entry of said side edges into said slots.

14. The locker shelf assembly of claim 10 wherein each shelf extension member has a width of approximately 3 inches and is hollow with 5 openings extending through the shelf extension member and the connector framework comprises an elongate center bar an 5 bridge frames which are mounted to and extend form either side of the center bar and the bridge frames are received in each shelf extension member and in one of the upper or lower shelves.
